(19) United States
(12) Patent Application Publication
(10) Pub. No.: US 2014/0341799 A1
(43) Pub. Date: Nov. 20, 2014

(54) RECYCLING OF COPPER INDIUM GALLIUM DISELENIDE

(71) Applicant: MIDSUMMER AB, Järfälla (SE)

(72) Inventors: Mark R. StJ. Foreman, Vara (SE); Anna M. Gustafsson, Goteborg (SE); Christian Ekberg, Ljungskile (SE)

(21) Appl. No.: 14/364,454

(22) PCT Filed: Dec. 14, 2012
(86) PCT No.: PCT/SE2012/051396

§ 371 Date: Jun. 11, 2014

Related U.S. Application Data
(60) Provisional application No. 61/570,844, filed on Dec. 15, 2011.

(30) Foreign Application Priority Data
Dec. 15, 2011 (SE) 1151203-5

(51) Int. Cl. C01B 19/00; C22C 30/02; C22C 28/00; C22B 58/00

(52) U.S. Cl. CPC C01B 19/004; C22B 58/00; C22C 30/02; C22C 28/00
USPC 423/509; 75/585; 420/587

(57) ABSTRACT

There is provided a method for providing selenium dioxide and a copper indium gallium residue from a material comprising a compound of formula (I) CuInₓGa₍₁₋ₓ₎Se₂ (I), wherein x has a value from 0.01 to 0.99, said method comprises the steps of: a) heating the material comprising the compound of formula (I) to at least 500° C., b) contacting the material with a gas flow comprising oxygen, and d) collecting the formed products. The method may be used in recycling in the field of solar cell technology.

### TECHNICAL FIELD

The present invention relates to recovery of valuable elements such as selenium. More specifically, the invention concerns a method, in which at least selenium is separated and/or recycled in the form of selenium dioxide from a compound having the chemical formula CuInₓGa₍₁₋ₓ₎Se₂, wherein x has a value from 0.01 to 0.99.This allows for recycling in the field of solar cell technology.

### BACKGROUND OF THE INVENTION

Environmental concerns have led to an ever increasing interest in renewable energy coming from natural sources such as, for instance, sunlight. Solar cells using sunlight for energy production have become widespread, and there is an ongoing development for making solar cells thinner while maintaining or increasing their efficiency in energy production.

For a long time, copper indium diselenide (CIS) has been used in materials for solar cells. More recently, copper indium gallium diselenide (CIGS) has shown to be useful for thin film solar cell production.

However, the utilization of the rare and valuable materials indium and gallium together with a constant need for selenium makes recycling necessary from both an environmental and economic perspective. Furthermore, in 2010 the European Commission identified both indium and gallium, along with twelve other materials, as critical raw materials with regard to supply shortage and economic impact.

In Photovoltaic Energy Conversion, 2003, Proceedings of 3^{rd} World Conference on Photovoltaic Energy Conversion, Kushiya, K. et al. methods are suggested where the CIGS material is removed from the substrate, purified and reused. However, no details are given on the purification or reuse.

Thin Solid Films, 361-362 (2000)278-282 discloses an electrochemical method to redeposit CIGS from an old solar cell to a new substrate. However, no attempt was made at separating the elements from the CIGS film.

U.S. Pat. No. 5,779,877 discloses a method for recycling of CIGS in which the CIGS material is treated with nitric acid to produce a leachate, which is subsequently electrolysed to remove a mixture of copper and selenium. Dissolution of the mixture in sulphuric or nitric acid followed by distillation affords selenium dioxide, which is reduced to selenium with the aid of sulphur dioxide. Further, gallium and indium are separated. The method includes a large number of steps.

Thin Solid Films, 361-362(2000)400-405 discloses that air annealing of CIGS results in gallium diffusion to the top of the layer, where it forms an oxide film of Ga₂O₃ estimated to be 200 nm in thickness, and that the creation of a Ga₂O₃ film on the surface can hinder the oxygen transport into the layer.

### SUMMARY OF THE INVENTION

There remains a need for alternative and/or improved methods of recycling of the constituents, in particular selenium, in compounds having the formula CuInₓGa₍₁₋ₓ₎Se₂ in which x has a value from 0.01 to 0.99.

It is an object of the invention is to overcome or at least mitigate some of the disadvantages associated with the prior art.

The present invention is based on the insight that SeO₂, i.e. selenium dioxide, is formed by heating a material comprising a compound of formula (I), i.e. CuInₓGa₍₁₋ₓ₎Se₂ wherein x has a value from 0.01 to 0.99, while subjecting it to a gas flow comprising oxygen. The SeO₂ may be further converted into elemental selenium in high yield and purity by reduction reaction using Riley reaction conditions, with the aid of sulphur dioxide as reducing agent or using any other reducing agent suitable for this purpose known in the art to the skilled person.

Thus, in a first aspect of the invention there is provided a method for providing selenium dioxide and a copper indium gallium residue from a material comprising a compound of formula (I),

CuInₓGa₍₁₋ₓ₎Se₂ (I),

wherein x has a value from 0.01 to 0.99,

said method comprises the steps of:
a) heating a material comprising a compound of formula (I) to at least 500° C.,
b) contacting the material with a gas flow comprising oxygen, and
d) collecting the formed products.

The material comprising the compound of formula (I) may be obtained from a solar cell sputtering target. The solar cell sputtering target may be crushed so that it is in the form of a powder.

Upon heating the material comprising the compound of formula (I), while contacting it with a gas flow comprising oxygen, an oxidation will take place so that selenium dioxide and a CIG, i.e. a copper indium gallium, residue are formed. The selenium dioxide and the residue may be collected separately from each other and may, if desired, be subjected to further transformations. Elemental selenium of high purity may be obtained when the SeO₂ is subjected to Riley reaction conditions or reduced with sulphur dioxide.

In a further aspect there is provided a copper indium gallium residue obtainable by the method as described hereinbefore or hereinbelow.

### DEFINITIONS

CIGS Copper Indium Gallium diSelenide

CIG Copper Indium Gallium

CIS Copper Indium diSelenide

GC-MS Gas Chromatography Mass Spectroscopy

ICP-MS Inductively Coupled Plasma Mass Spectrosopy

ICP-EOS Inductively Coupled Plasma Optical Emission Spectroscopy

ml millilitre

mm millimeter

micrometer

min. minute(s)

ng nanogram

nm nanometer

rt room temperature

wt weight

XRD X Ray powder Diffraction

### BRIEF DESCRIPTION OF THE DRAWINGS

FIG. 1 shows the selenium content in the remaining CIG residue after oxidation of a material comprising CIGS as a function of the temperature at which the oxidation is performed.

FIG. 2 shows XRD patterns for (a) a material comprising CIGS before oxidation, (b) the CIG residue after oxidation at 800° C. for 24 hours and (c) the CIG residue after oxidation at 1000° C. for 24 hours.

### DETAILED DESCRIPTION

In a first aspect, there is provided a method for providing selenium dioxide and a copper indium gallium residue from a material comprising a compound of formula (I),

CuInₓGa₍₁₋ₓ₎Se₂ (I),

wherein x has a value from 0.01 to 0.99,

said method comprises the steps of:
a) heating a material comprising the compound of formula (I) to at least 500° C.,
b) contacting the material with a gas flow comprising oxygen, and
d) collecting the formed products.

It is to be understood that x may be non-integers between 0.01 and 0.99.

In an embodiment of the invention, there is provided a method as defined hereinbefore or hereinafter, wherein x in the compound of formula (I) is from 0.01 to 0.99, from 0.1 to 0.9, from 0.2 to 0.8 or from 0.3 to 0.7. Alternatively, x may be about 0.95. In this document, a compound of formula (I) as defined hereinbefore or hereinafter in which x in the compound of formula (I) is from 0.01 to 0.99 is denominated CIGS.

The material comprising a compound of formula (I) may be obtained from a solar cell sputtering target, possibly a used solar cell sputtering target, the layer deposited on sputtering masks during sputtering, solar cells rejected in the quality control or used solar cells.

It will be a appreciated that the expression “a material” is understood to mean one or more materials.

The solar cell sputtering target may be crushed, for instance with a mortar, to provide a powder. Thus, in one embodiment of the invention there is provided a material comprising a compound of formula (I) in the form of a powder. In a further embodiment, the material comprising a compound of formula (I) is in the form of a powder, in which 60 to 70 wt % has a particle size between 0.25 and 2.0 mm. In a further embodiment, there is provided a material comprising a compound of formula (I) in the form of a granulate, flakes or chips.

The compound of formula (I) may have a selenium content from 30 to 70 wt %. In a further embodiment, the compound of formula (I) may have a selenium content of approximately 50 wt %.

It will be appreciated that the selenium content in the compound of formula (I) is at least 50 mol %. In the compound of formula (I) the total content of indium and gallium may be 25-30 mol % and/or the total content of copper may be 20-25 mol %. In an embodiment of the invention, the total content of gallium in the compound of formula (I) may be 1-25 mol % or 5-7 mol %.

The material comprising the compound of formula (I) is heated to a temperature of at least about 500° C. and is contacted with a gas flow comprising oxygen. This results in oxidation of the material comprising a compound of formula (I). In this document, the term “contacted” in the context of “contacting the material” is intended to include, but is not limited to, a gas flow above, beneath and/or through the material.

The material comprising the compound of formula (I) may be heated to a temperature between 500 and 1200° C. In a further embodiment, the material comprising the compound of formula (I) is heated to 500, 600, 700, 800, 900, 1000, 1100 or 1200° C. Alternatively, the material comprising the compound of formula (I) may be heated to about 800-1200° C., 800-1000° C. or 900-1000° C.

The oxidation of the material comprising a compound of formula (I) may be performed by simultaneous heating and exposure to a gas flow comprising oxygen. Accordingly, in a further embodiment steps a) and b) of the method of the present invention are at least partly overlapping. When steps a) and b) are overlapping they take place simultaneously. It is to be understood that steps a) and b) of the method of the present invention may be performed in any order; i.e. step a) may be performed or started before step b) and vice versa.

The heating may be turned off after or during step a) or b) in the method as defined hereinbefore or hereinafter. When the heating is turned off the temperature of the material will decrease gradually allowing for oxidation during a certain time. When the temperature of the material is less than about 500° C. very little oxidation will take place.

The heating of the material comprising the compound of formula (I) may be achieved with the aid of an oven such as tube furnace, fluidized bed furnace or rotating furnace.

It will be understood that the method of the invention is performed at atmospheric pressure. However, the method of the invention may also be performed at a pressure different from atmospheric pressure.

In order to allow for oxidation of the material comprising the compound of formula (I), the gas flow comprises oxygen. For instance, the gas flow may be air, pure oxygen gas (O₂), ozone (O₃) or mixtures thereof.

The method as defined hereinbefore or hereinafter may include an additional step c) following on from step b) and preceding step d) in which:
c) the material is cooled.

Accordingly, in a further embodiment there is provided a method for providing selenium dioxide and a copper indium gallium residue from a material comprising a compound of formula (I),

CuInₓGa₍₁₋ₓ₎Se₂ (I),

wherein x has a value from 0.01 to 0.99,

said method comprises the steps of:
a) heating a material comprising a compound of formula (I) to at least 500° C.,
b) contacting the material with a gas flow comprising oxygen,
c) cooling of the material, and
d) collecting the formed products.

In a further embodiment, in step c) in the method as defined hereinbefore or hereinafter, the material is cooled to room temperature. In this document, the expression room temperature intended to mean 20 to 25° C. at atmospheric pressure. The cooling may take place in various ways known to the person skilled in the art. For instance, the gas flow comprising oxygen may contribute to the cooling of the material. Alternatively, the gas flow comprising oxygen may be exchanged for another gas flow comprising cheaper gas or gas mixtures. In a further embodiment, the gas used during step c) may be cooled to a temperature below room temperature. In addition, water or other coolants may be used to cool the furnace.

The gas flow may be turned off after or during step b), c) or d) in the method as defined hereinbefore or hereinafter. In one embodiment, the gas flow is turned off after step c) and before step d).

The sample comprising a compound of formula (I) may be heated while it is contacted with a gas flow comprising oxygen from 6 to 36 hours. However, the method is not limited to this reaction time. In one aspect, there is provided a method in which steps a) and b) are overlapping for 24 hours.

The method as defined hereinabove or hereinafter allows for collecting the formed SeO₂ and the remaining CIG residue.

The SeO₂ sublimes by using the method of the present invention and is easy to collect and further transform into elemental selenium in high yield and purity using standard conditions such as Riley reaction conditions or reaction with sulphur dioxide. Typically, the yield is at least 90% and the purity at least 99%. Accordingly, the present invention allows for easy removal of selenium in the form of SeO₂from a material comprising a compound of formula (I) as defined hereinbefore or hereinafter thereby allowing for recycling. This is advantageous in the field of solar cell technology where the purity requirements are very high, and may also be of considerable use in other areas.

In one aspect of the present invention, there is provided a CIG residue that is obtainable according to the method of the present invention wherein x has a value from 0.01 to 0.99 in the compound of formula (I) used in step a). While not wishing to be bound by any specific theory it is believed that the CIG residue comprises oxides of copper, indium and gallium. The CIG residue has a low selenium content. The selenium content of the CIG residue may be equal to or less than 6 wt %. In a further embodiment of the invention, the CIG residue has a selenium content of 0 to 10 wt %. In still an embodiment of the invention, the CIG residue has a selenium content of 0 to 5 wt %. Yet an embodiment of the present of the invention is to provide a CIG residue having a selenium content of 0 to 1 wt %.

In an embodiment of the invention there is provided a CIG residue as defined hereinbefore or hereinafter, which comprises at least two layers in which the selenium content differs from each other. For instance, the selenium content in one of the layers may be as low as about 0.3 wt % whereas the other layer has a selenium content of about 5 wt %. The layers may be separated and collected.

Still an embodiment of the invention is a method as defined hereinbefore or hereinafter in which the material comprising the compound of formula (I) is stirred or mixed during steps a) and/or b) thereby providing a CIG residue having only one layer that is lacking selenium or has a uniform and low content of selenium. By low content is meant a selenium content between 0 and 10 wt %. The stirring may be achieved by mechanical means. The mixing may be achieved by using a fluidized bed.

There is also provided the use of the CIG residue for recycling. The CIG residue may be recycled in its entirety or separated into copper, indium and gallium.

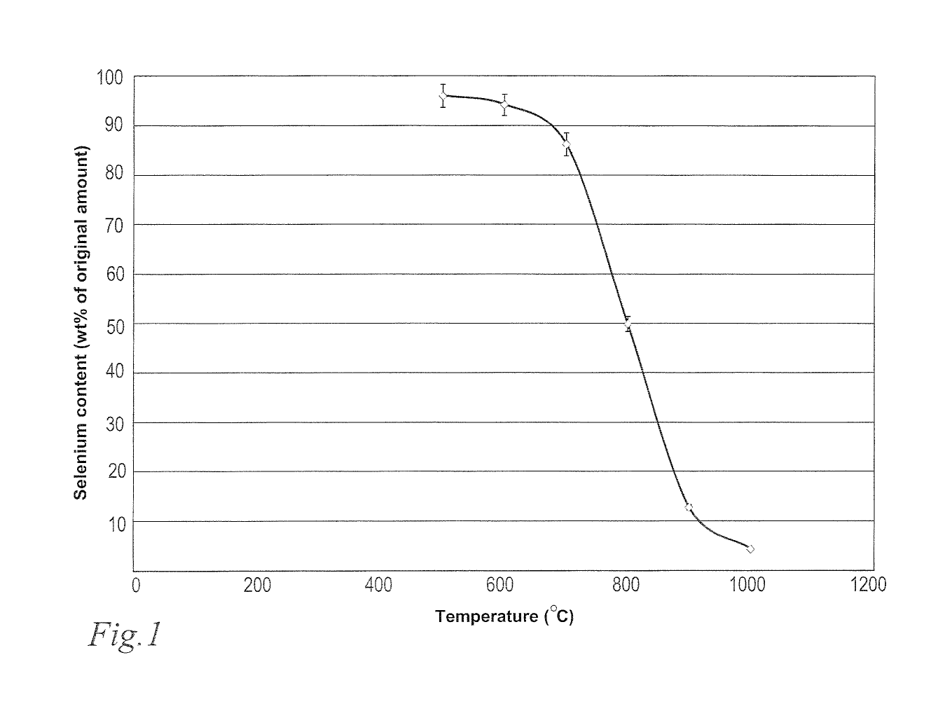

FIG. 1 shows oxidation of a material comprising CIGS in the form of a powder and having a selenium content of approximately 50 wt % when it is subjected to an oxygen gas flow of 200 ml/min during 24 hours at various temperatures and at atmospheric pressure. The selenium content of the resulting CIG material is shown in wt % of the amount of selenium in the material comprising CIGS as a function of the temperature at which the experiment was performed. Experiments were performed at 500, 600, 700, 800 and 1000° C.

The selenium content in the CIG residue varied as follows in wt % of the original amount of selenium in the CIGS material:
500° C.: 95 wt %
600° C.: 94 wt %
700° C.: 86 wt %
800° C.: 50 wt %
900° C.: 13 wt %
1000° C.: 4 wt %

Since the CIGS material originally had a selenium content of 50 wt % this implies that the selenium content in the CIG residue is approximately 50 wt % of the values above. For instance, the experiment performed at 800° C. resulted in a CIG residue having a selenium content of approximately 25 wt %. In the same way, the experiment performed at 1000° C. resulted in a CIG residue having a selenium content of approximately 2 wt %.

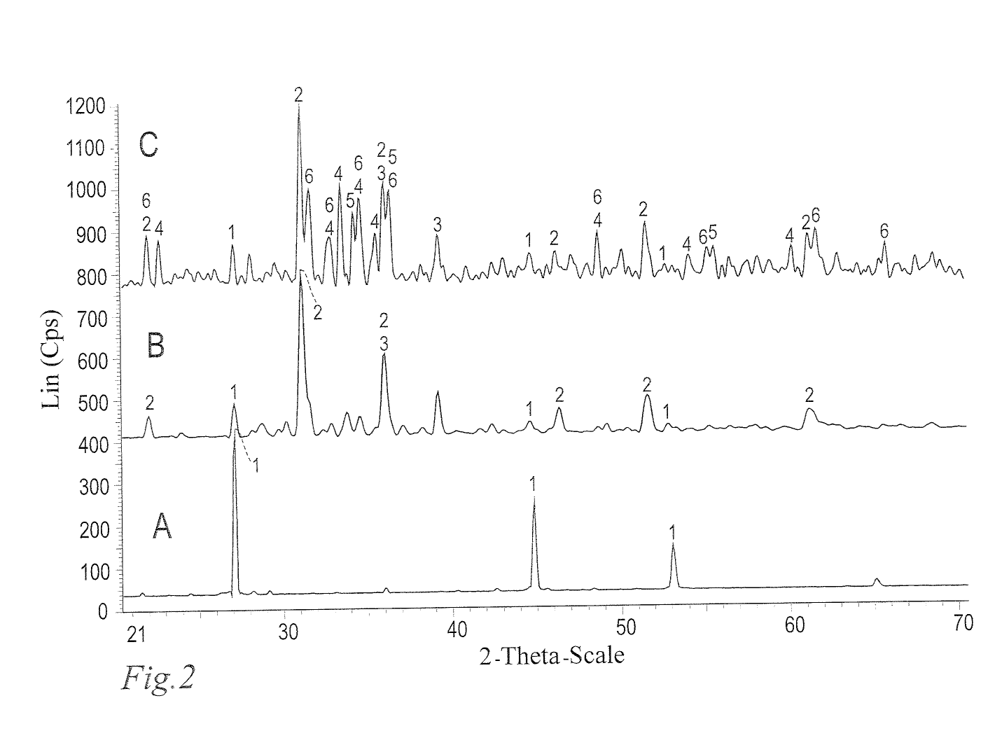

FIG. 2 shows X ray powder diffraction patterns for a material comprising CIGS in the form of a powder and having a selenium content of approximately 50 wt % before and after subjecting the material to an oxygen gas flow of 200 ml/min during 24 hours at 800° C. and 1000° C. at atmospheric pressure, respectively. In (a) the XRD pattern is shown for the material comprising CIGS before oxidation. In (b) the XRD pattern is shown for the CIG material after oxidation at 800° C. In (c) the XRD pattern is shown for the CIG material after oxidation at 1000° C. In (a), (b) and (c) the peaks have been denominated 1, 2, 3, 4, 5 and 6. The peaks are attributed to the following materials: 1: CIGS; 2: In₂O₃; 3: CuO; 4: Cu₂In₂O₅; 5: Ga₂O₃; and 6: CuGaInO₄.

Thus, it can be seen that the CIG residue comprises oxides of copper, indium and gallium.

The examples given below are meant to illustrate the present invention. Hence, the invention should not be considered as limited to the given examples.

### EXAMPLES

Starting Material

A sample comprising CIGS provided by Midsummer AB was used as a starting material. The sample was crushed in a marble mortar to a powder and this material was used as a starting material for all the oxidation experiments. The particle size of the powder was determined by sieving. 5.5 g of starting material was sieved through a mesh 10 sieve followed by mesh 60 and finally a mesh 200 (ASTM E-11, W. S Tyler inc.). The material passing each sieve was weighed to give the particle size distribution.

Oxidation of GIGS

13.5 g of the starting material was placed in a furnace boat and the container was placed in the middle of a quartz tube in a tube furnace. The temperature in the furnace was regulated with a thermocouple on the outside of the quarts tube. An oxygen cylinder (99%, AGA) was connected to one end of the quartz tube through plastic tubing and a flow meter. The gas flow through the furnace was adjusted to 200 ml/min. The other end of the quartz tube was connected to a cooler in order to trap the selenium dioxide that did not sublime in the quartz tube directly outside the furnace. The cooler was cooled with water at 20° C. and the discharge gas was bubbled through ultrapure water to collect the last of the selenium dioxide. Six different experiments were done, each at a different temperature (500, 600, 700, 800, 900 and 1000° C.). The reaction was allowed to proceed for 24 h, after which the furnace was turned off and allowed to cool. When the furnace had reached room temperature the gas flow was turned off and the selenium dioxide crystals were collected.

Two additional tests were done at 800° C. to evaluate the effect of the amount of starting material and the influence of the gas flow. In the first test, the amount of starting material was halved to 6.75 g and the gas flow was kept at 200 ml/min. In the second test, the amount of starting material was kept at 13.5 g and the gas flow was increased to 400 ml/min. All other parameters were kept constant.

Reduction of Selenium Dioxide—Riley Reaction (Oxidation of Deoxybenzoin to Benzil)

1.8 g (0.016 mol) selenium dioxide from the oxidation of CIGS was dissolved in 6.25 ml glacial acetic acid (pro analysis, 100%, Merck) and 2.975 g (0.015 mol) deoxybenzoin (98%, Acros organics) was added. The mixture was heated to 126° C. and refluxed for 3 h. The cooled solution was decanted and the elemental selenium was washed with dietylether (99+%, Acros organics). The organic product was washed with ultrapure water, a saturated solution of sodium bicarbonate and then again with brine, after which it was dried with sodium sulphate and concentrated under reduced pressure.

Reduction of Selenium Dioxide—Sulphur Dioxide

1 g (0.009 mol) of selenium dioxide was placed in a dreschel bottle and dissolved in 50m1 ultra pure water. The solution was heated to 80° C. and stirred with a magnetic stirrer. Sulphur dioxide (99.8%, AGA) was bubbled through the solution at a flow rate of 40 ml/min. After 15 min the gas flow was stopped and the selenium was collected, decanted, washed with ultrapure water and allowed to dry before it was weighed.

Characterisation

Samples of the CIGS material, before and after the oxidation reactions, were dissolved in acid and the composition of the material was subsequently analysed with ICP-OES (Thermo Scientific iCAP 6500). The starting material was dissolved in nitric acid (puriss, 69%, Sigma-Aldrich) and the residues was dissolved in hot aqua regia. The aqua regia was prepared by mixing nitric acid (puriss, 69%, Sigma-Aldrich) and hydrochloric acid (puriss, 37%, Sigma-Aldrich) with a molar ratio of 1:3 respectively. Standard solutions containing 0.5 μg/ml, 1 μg/ml, 10 μg/ml and 40 μg/ml cupper, indium, gallium and selenium was prepared by dilution of ICP-OES standard solutions (1000 μg/ml, Ultra Scientific). All samples and standards was diluted with a solution of 0.1 M nitric acid made from suprapure nitric acid (65%, Merck) and ultrapure water obtained from a Milli-Q system (>18 MΩ, Millipore Milli-Q Plus 185).

In order to determine the phases in the CIGS material, before and after the oxidation, X-ray powder diffraction (Siemens D5000 diffractometer), with a Cu Kα-radiation source and a scintillation detector, was used. The results were evaluated using the Joint Committee of Powder Diffraction Standards database.

In order to determine the amount of selenium dioxide remaining in the reaction liquid after the reduction of selenium dioxide with sulphur dioxide the selenium content in the liquid was analysed with ICP-OES (Thermo Scientific iCAP 6500).

The purity of the recycled selenium with respect to chromium, manganese, iron, nickel, copper, zinc, gallium and indium was determined by using a combination of ICP-MS (Perkin Elmer, ELAN 6000) and ICP-OES (Thermo Scientific iCAP 6500). A solution containing 1000 μg/ml selenium was prepared by dissolution of 1 g of selenium in 69,3 ml suprapure nitric acid (65%, Merck) followed by dilution up to 1000 ml with ultrapure water. ICP-MS standards (10 μg/ml, High-Purity Standards) were used to prepare a solution containing 10 ng/ml of all the analysed elements. From these solutions samples containing 1000 μg/ml selenium and 0, 0.1, 0.5 and 1 ng/ml of the impurities were made and analysed with ICP-MS. All samples and standards was diluted with a solution of 1 M nitric acid made from suprapure nitric acid (65%, Merck) and ultrapure water obtained from a Milli-Q system (>18 MΩ, Millipore Milli-Q Plus 185). Yttrium was used as an internal standard.

The exact concentration of selenium in the selenium solution was determined with ICP-OES. The solution was diluted with 1M suprapure nitric acid and standard solutions containing 0.5 μg/ml, 1 μg/ml, 10 μg/ml and 40 μg/ml selenium was prepared by dilution of ICP-OES standard solutions (1000 μg/ml, Ultra Scientific).

The organic product from the Riley oxidation was dissolved and diluted to a concentration of 16 mg/l in acetone (pro analysis, Fischer Scientific) and analysed with GC-MS (Hewlet Packard, GI800A GCD System) using a sp2330 column. As a reference a solution containing a mixture of deoxybenzoin and benzil was analysed.

To further determine the purity of the recycled selenium a neutron activation analysis (NAA) was made in the 2MW JEEP II reactor at the Institute for Energy Technology in Kjeller, Norway. Samples of selenium containing 0, 0.1, 1, 10 and 100 ppm of iron were prepared. 0.1 g selenium or 0.14 g selenium dioxide respectively was placed in quartz ampoules. An ICP-OES standard (1000 μg/ml, High-Purity Standards) was used to prepare solutions containing 0.1, 1, 10 and 100 ng/ml of iron. Ultrapure water was used for the dilution. 0.1 ml of the solutions was added to the respective selenium samples. The ampoules were sealed and sent to the reactor, where the samples were irradiated for a total of 123 hours and 23 minutes. After the irradiation the samples were analysed with high purity germanium detectors (HPGe, Canberra γ-analyst, ORTEC and Tennelec, respectively). The 1099 and 1291 keV gamma lines of ⁵⁹Fe were used in the measurements. The accuracy of the results was evaluated using the methods developed by the Eurachem organisation.

Results

The particle Size Distribution of the Starting Material

The result of the examination of the particle distribution of the starting material can be seen in Table 1. In Table 1, the particle distribution of the starting material given as the percentage of weight of the material passing through a certain mesh compared with the weight of the starting material.

TABLE 1

| | | Share of material |
|---|---|---|
| | Sieve size | passing the mesh |
| Mesh | (mm) | (wt %) |
| 10 | 2.0 | 92 |
| 60 | 0.25 | 25 |
| 200 | 0.075 | 9.5 |

From the result can be seen that approximately 8 wt % of the material has a particle size larger than 2.0 mm while approximately 10 wt % has a particle size smaller than 75pm. The majority of the material has a particle size between 0.25 and 2.0 mm.

Oxidation of CIGS

Analysis of the starting material shows that it contains approximately 50 wt % selenium, Table 2.

TABLE 2
The composition of the starting material

| Cu(wt %) | In(wt %) | Ga(wt %) | Se(wt %) |
|---|---|---|---|
| 17.42 ± 0.20 | 28.32 ± 0.52 | 5.31 ± 0.08 | 48.95 ± 0.79 |

As can be seen in FIG. 1 the selenium content in the CIG residues from the oxidation decreases with higher temperature. At 1000° C. only 4 wt % of the original amount of selenium is left in the residue.

When the CIG residues from the oxidation tests were inspected it was noticed that it seemed to contain two different layers, a porous, gray and blue top layer and a more compact yellow bottom layer. This was more pronounced at higher temperatures. Samples of the two layers in the residue from the test at 1000° C. were analysed. The result can be seen in Table 3.

TABLE 3
The composition of the top and bottom layers
of the residue after oxidation at 1000° C.

| | Cu (wt %) | In (wt %) | Ga (wt %) | Se (wt %) |
|---|---|---|---|---|
| Top layer | 51.52 ± 0.40 | 45.92 ± 0.53 | 2.28 ± 0.2 | 0.28 ± 0.04 |
| Bottom layer | 27.01 ± 0.22 | 56.09 ± 0.68 | 11.38 ± 0.11 | 5.52 ± 0.07 |

It can be seen that all the remaining selenium in the residue is concentrated to the bottom layer. It can also be seen that the copper concentration is higher in the top layer and that almost all the gallium has been concentrated to the bottom layer.

The result from the XRD analysis for the starting material and the residues after treatment at 800 and 1000° C. is shown in FIG. 2.

Analysis of the residues from the additional tests at 800° C. showed that the decreasing the amount of starting material did not affect the deselenization. Meanwhile, an increase in the gas flow, from 200 to 400 ml/min, decreased the deselenization. After the test with a gas flow of 400 ml/min the selenium content in the residue was 57 wt % of the original amount compared to 48 wt % after the test with a flow of 200 ml/min.

Reduction of Selenium Dioxide—Riley Reaction (Oxidation of Deoxybenzoin to Benzil)

The Riley reaction was monitored by GC MS and resulted in 1.19 g of selenium corresponding to a yield of 90.7%. GC MS showed that the organic product was pure benzill. The yield was 3.1 g equivalent to 96.6 wt.

Reduction of Selenium Dioxide—Sulphur Dioxide

The reaction was first performed at room temperature and resulted in red selenium that was difficult to collect due to the fine particle size and surface activity of the red selenium. However, upon heating to 80° C. the red selenium was observed to gradually transform into grey selenium. The grey selenium is not surface active and forms larger particles which makes it more easily collected. An additional advantage of this transformation is that the formation of new red selenium can be distinguished. The time needed for complete reduction can thereby be easily determined. It was concluded that 15 minutes was sufficient time for complete reaction.

The reaction resulted in 0.67 g of selenium corresponding to a yield of 93.8 wt %. Analysis of the liquid from the reaction showed that the amount of selenium, that had not been reduced, was less that 10 mg (1.4 wt %). This means that the selenium dioxide has been almost completely reduced.

Purity of Recycled Selenium

The purity of selenium from both reduction experiments were analysed along with the purity of the selenium dioxide from the oxidation test at 1000° C., the same selenium dioxide that was used in the reduction experiments. The selenium dioxide was analysed to see possible differences in the purity before and after the reduction. Also, the difference in purity depending on the reduction method used was of interest. The results from the ICP-MS measurements were analysed and the concentrations of the different impurities in the selenium were calculated, see Table 4.

TABLE 4
The concentration of impurities in the recycled selenium and in the selenium dioxide.

| | Sample | | | | | | | |
|---|---|---|---|---|---|---|---|---|
| | Cr | Mn | Fe | Ni | Zn | Cu | Ga | In |
| | (ppm) | (ppm) | (ppm) | (ppm) | (ppm) | (ppm) | (ppm) | (ppm) |
| Selenium | 0.17 ± 0.01 | <0.1 | 4.23 ± 0.27 | 0.26 ± 0.01 | 0.30 ± 0.01 | 5.49 ± 0.22 | 0.35 ± 0.01 | 3.57 ± 0.22 |
| dioxide | | | | | | | | |
| Selenium - | 0.79 ± 0.03 | <0.1 | 9.81 ± 0.75 | 0.51 ± 0.02 | 0.43 ± 0.02 | 13.5 ± 2.86 | 3.45 ± 0.26 | 6.55 ± 0.94 |
| Riley reaction | | | | | | | | |
| Selenium - | 0.23 ± 0.01 | <0.1 | 6.22 ± 0.32 | 0.34 ± 0.02 | 0.18 ± 0.02 | 5.58 ± 0.46 | 0.29 ± 0.01 | 2.04 ± 0.10 |
| Sulphur dioxide | | | | | | | | |
| reaction | | | | | | | | |

Chromium, manganese, iron, nickel and zinc were analyzed since they pose a problem in the solar cell production by decreasing the efficiency of the solar cells. The concentration of chromium, manganese, nickel and zinc in the selenium was determined to be below 1 ppm for each element. The iron concentration was between 4 and 10 ppm for all selenium materials. Copper, indium and gallium are not viewed as a problem, but they were analyzed since it was of interest to know if there were any residues in the selenium. The concentration of these elements was determined to be below 15 ppm in all cases.

From these results the purity of the recycled selenium was calculated and can be seen in Table 5.

TABLE 5

| | Purity* | Purity** |
|---|---|---|
| | (wt %) | (wt %) |
| Selenium dioxide | 99.9995 ± 2.72E−05 | 99.9986 ± 5.70E−05 |
| Selenium - Riley | 99.9988 ± 7.52E−05 | 99.9965 ± 3.12E−04 |
| reaction | | |
| Selenium - Sulfur | 99.9993 ± 3.22E−05 | 99.9985 ± 5.74E−05 |
| dioxide reaction | | |

The purity of the selenium dioxide from the oxidation and for the recycled selenium and with respect to
*Cr, Mn, Fe, Ni and Zn,
**Cr, Mn, Fe, Ni, Zn, Cu, Ga and In. The uncertainty corresponds to one standard deviation.

The purity with respect to the critical elements, chromium, manganese, iron, nickel and zinc, was higher than 5N (99.999 wt %) for both the selenium dioxide and the selenium from the sulfur dioxide reaction. The purity of the selenium from the Riley reaction was a little lower, but still almost 5N. The concentration of copper, indium and gallium in the recycled selenium was higher than the concentration of the critical elements, but the overall purity was still higher than 4N (99.99%). A comparison between the two different reduction methods gave that the Riley reaction gave a somewhat lower purity.

1. A method for providing selenium dioxide and a copper indium gallium residue from a material comprising a compound of formula (I)
CuInₓGa₍₁₋ₓ₎Se₂ (I),
wherein x has a value from 0.01 to 0.99,
said method comprises the steps of:
a) heating a material comprising the compound of formula (I) to at least 500° C.,
b) contacting the material with a gas flow comprising oxygen, and
d) collecting the formed products product(s).

2. A method according to claim 1, wherein x is 0.95.

3. A method according to claim 1, wherein the material is a solar cell sputtering target.

4. A method according to claim 1, wherein the material is heated to a temperature from 500° C. to 1200° C.

5. A method according to claim 1, wherein the heating is performed at 500, 600, 700, 800, 900 or 1000° C.

6. A method according to claim 1, wherein steps a) and b) are at least partly overlapping.

7. A method according to claim 1, wherein the time for overlap of steps a) and b) is from 6 to 36 hours.

8. A method according to claim 1, wherein the heating is turned off after or during step a) or b).

9. A method according to claim 1, further comprising a step c) following on from step b) and preceding step d) and in which: c) the material is cooled.

10. A method according to claim 9, wherein the material is cooled to room temperature.

11. A method according to claim 1, wherein the gas flow consists of air, O₂, O₃ or mixtures thereof.

12. A method according to claim 9, wherein the gas flow is turned off after or during step b), c) or d).

13. A method according to claim 1, wherein the collected product(s) is/are selenium dioxide and/or a copper indium gallium residue.

14. A copper indium gallium residue obtainable by the method according to claim 1.
